(19) United States
(12) Patent Application Publication
(10) Pub. No.: US 2018/0220672 A1
(43) Pub. Date: Aug. 9, 2018

(54) METHOD FOR PRODUCING A CONSUMABLE PRODUCT

(71) Applicant: KMB PRODUKTIONS AG, Felben (CH)

(72) Inventor: Guido Knobel, Kreuzlingen (CH)

(73) Assignee: KMB PRODUKTIONS AG, Felben (CH)

(21) Appl. No.: 15/580,793

(22) PCT Filed: Jun. 17, 2016
(86) PCT No.: PCT/EP2016/063974

§ 371 Date: Dec. 8, 2017

(30) Foreign Application Priority Data
Jun. 19, 2015 (DE) 10 2015 109 824.5
Aug. 3, 2015 (DE) 10 2015 112 735.0

(51) Int. Cl. A23G 1/00; A23G 1/21; A23G 1/54

(52) U.S. Cl. CPC A23G 1/0076; A23G 1/545; A23G 1/21

(57) ABSTRACT

A method for producing a consumable product (18), in particular a chocolate product, from at least two shell shapes (13, 13.1, 13.2), which are connected to one another, at least in part, along their shell peripheries (12, 12.1, 12.2), wherein a liquid consumable substance (3) is introduced into a mold (2) and then at least one die (4) is plunged into the consumable substance (3) and, by virtue of the consumable substance (3) at least partially solidifying in the mold, a shell shape (13, 13.1, 13.2) is imparted to said consumable substance, and wherein a second die (5) is introduced into the shell shape (13) and, by virtue of said die, a peripheral region of the shell shape is compressed in the upward direction.

### BACKGROUND OF THE INVENTION

The invention relates to a method for producing a consumable product, in particular a chocolate product, from at least two shell shapes, which are connected to one another, at least in part, along their shell peripheries, wherein a liquid consumable substance is introduced into a mold and then at least one die is plunged into the consumable substance and, by virtue of the consumable substance at least partially solidifying in the mold, a shell shape is imparted to said consumable substance, and to an apparatus for this purpose.

Chocolate products are produced in a variety of different shapes and designs. The present invention is concerned, in particular with the production of hollow chocolate products, in particular hollow three-dimensional figures for the confectionary industry. However, the present invention should not be limited to chocolate products; it can be used for any consumable product which is produced by virtue of the appropriate substance being pressed in a mold.

For example, DE 102 21 524 A1 discloses a method for producing consumable articles with an outer shell from a substance which is introduced into a mold, wherein a thermally controlled die plunges into said substance and causes the substance to solidify. Since the amount of substance required to produce an exact shell can never be calculated precisely, there is usually extra substance introduced into the mold. In the case of the invention described here, an excess amount of substance will escape over a mold periphery, wherein the excess amount of substance on the mold periphery is separated off from the shell by means of the die. Said excess amount of substance is then scraped off from the mold.

A further problem arises when use is made of a cooled die for molding a higher-temperature consumable substance. In normal ambient air, this cooled die, which usually consists of metal, becomes covered in moisture. This moisture covering then results in ice forming on the die, which, in addition, can lead in turn to water marks forming on the consumable article. At the same time, it has to be ensured that the die can also be easily released from the consumable article and the consumable article does not remain stuck to the die. In the past, a release agent has usually been applied to the die for this purpose.

DE 197 32 036 A1 counteracts this disadvantage in that the dew point of the atmosphere surrounding the consumable article is kept below the temperature of the die. This means that the air around the die is dehumidified to the extent where it is no longer possible for the die to become covered in moisture. The die remains dry and can thus also be easily removed again from the consumable article. Water marks are avoided.

A further problem in the production of, in particular, hollow three-dimensional products is posed by the operation of joining together two identical shells or shell shapes. For this purpose, the corresponding shell peripheries have to form the best possible contact surface. To this end, WO95/32633 A1 proposes that the die should be enclosed by a ring. However, an annular groove is formed between the ring and die, and some of the excess consumable-article substance can flow into said annular groove. This leaves behind an upwardly projecting lip. Two correspondingly shaped shells then have to be removed from the respective mold and positioned one upon the other. When the shells are being positioned one upon the other, the respective lips are bent over inward, the hope being that this will give rise to the largest possible contact surface. However, this arrangement has serious disadvantages. First of all, there is a great risk of the upper lip region which has flowed into the annular groove being taken along when the die is moved out of the shell shape produced. There is also a risk of chocolate substance, or a substance of the liquid consumable article, flowing into the gap between the ring and die, which renders frequent cleaning of the latter necessary. In addition, it is necessary for the two shell shapes first of all to be removed from their respective mold cavities. This can take place only when the shell shapes have solidified. For the joining-together operation, they then have to be heated again in the first instance so that the lips produced above can be bent over. It is highly questionable whether the desired contact surfaces are also produced.

### SUMMARY OF THE INVENTION

The object of the present invention is to supply a method and an apparatus of the aforementioned type which can straightforwardly produce very good contact surfaces between two shell shapes.

The object is achieved in that a second die is introduced into the shell shape and, by virtue of said die, a peripheral region of the shell shape is compressed in the upward direction.

This means that the compressed formation is produced in a second portion of the apparatus according to the invention, a shell shape with a clearly defined peripheral region being produced in the first portion. The compressed formation is produced without the shell shape having to be reheated; rather, immediately following the first die, once the shell shape has been moved beneath the second die, the second die is lowered into the shell shape, which is still deformable at this point in time. This is a quite significant advantage of the present invention since, according to the method of the invention, the consumable article, despite contact with the cooled die, remains sufficiently liquid for a perfect connection between the shells to be achieved, even without additional heating, when the molds are swung together. However, if the die cools the shell to such a pronounced extent that the compressed periphery is no longer liquid, the periphery has to be heated up prior to the molds being swung together. In addition, it could also be the case that the cold press is installed on a different installation and, in the different installation, the swinging-together apparatus is reached only after a relatively long period of time, in which case the compressed periphery is no longer liquid.

It is preferably immediately following the compression operation, then, that two molds with correspondingly compressed shell shapes are positioned one upon the other, and therefore it is also the case here that the operations of deforming the compressed formation and of joining together the shell peripheries take place with the consumable article still in a relatively soft state. The contact surface is significantly increased in size by the compressed formations, wherein the rest of the shell peripheries remains in the previously defined, matching shape, and this therefore ensures a good contact surface throughout.

The compression operation itself takes place preferably along the inner periphery of the shell periphery of the shell shape, and therefore, when two shell shapes are joined together, the two compressed formations coming into contact with one another come together in the inward direction, in the direction of the cavity, to form a “kiss mouth”. This increases the size of the contact surface.

So that a possibly slightly uneven shape can be pressed flat, the die has a level peripheral edge. A peripheral edge with a groove defines the press-in depth of the die. However, this is not imperative; it is also possible for the peripheral edge to be of smooth design to allow for a freely adjustable pressing depth.

The second die can be designed to be identical to the first die, but the second die presses to a somewhat lower depth so that a compressed formation is produced. It may also be the case, however, that compression takes place in that an outer contour of the second die differs slightly from that of the first die. For the sake of simplicity, the second die can be designed to be wider at least in the vicinity of the region in which the compressed formation is to be produced, i.e., in this region, the second die has a larger diameter than the first die. For example, it is possible here for the second die to have a slightly outwardly and upwardly extending cone of, for example, an angle of approximately 15°, which is different from the first die in this region. Said angle, however, is not imperative. This widening causes somewhat more consumable substance to be forced out of the mold cavity, as a result of which the compressed formation is produced.

The present invention, of course, produces not just spherical shell shapes, but shell shapes of any conceivable geometrical configuration. The widening of the die and/or the term diameter should also be understood accordingly. The term widening covers all the possible measures which make it possible for a small amount of the consumable article to be compressed.

### DESCRIPTION OF THE FIGURES

Further advantages, features and details of the invention can be gathered from the following description of preferred exemplary embodiments and with reference to the drawing, in which:

FIG. 1 shows a schematically illustrated side view of a first part of the apparatus according to the invention;

FIG. 2 shows a schematically illustrated side view of a first use position of the apparatus according to the invention, alongside an enlargement of a sub-region;

FIG. 3 shows a schematically illustrated side view of a further use position of the first part of the apparatus according to the invention;

FIG. 4 shows a schematically illustrated perspective view of a further operating step of the method according to the invention;

FIG. 5 shows a schematic and perspective view of a further method step, which provides an alternative to FIG. 4;

FIG. 6 shows a schematically illustrated side view of a shell shape produced by the first part of the apparatus according to the invention;

FIG. 7 shows a schematically illustrated side view of a second part of the apparatus according to the invention;

FIG. 8 shows a side view of the apparatus according to the invention from FIG. 7 in a use position, alongside an enlarged sub-region;

FIG. 9 shows a schematically illustrated side view of that part of the apparatus according to the invention which is shown in FIG. 7, this time in a further use position;

FIG. 10 shows a schematically illustrated side view of part of the apparatus according to the invention produced following the further operating step, and also a sub-region illustrated on an enlarged scale;

FIG. 11 shows a perspective view of two parts of the apparatus according to FIG. 10, which are being swung together;

FIG. 12 shows a cross section through a chocolate product produced by the method according to the invention, alongside an enlarged sub-region; and

FIG. 13 shows side views of different embodiments of a second die.

### DETAILED DESCRIPTION

An apparatus according to the invention for producing a chocolate product has a mold 1, which contains a chocolate substance 3 in a mold cavity 2. Said mold 2 is assigned a first die 4.

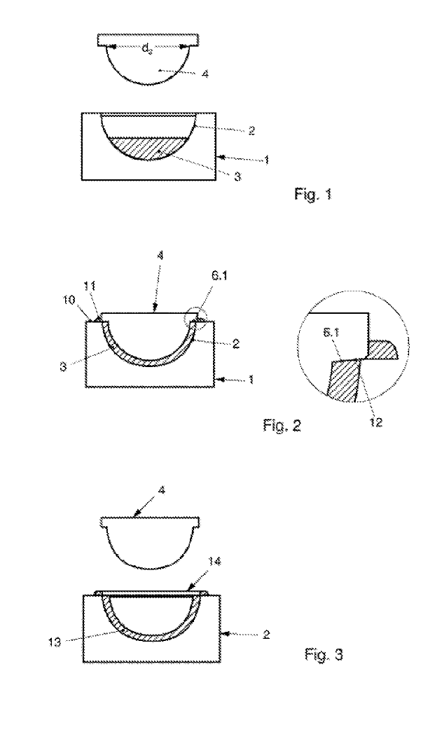

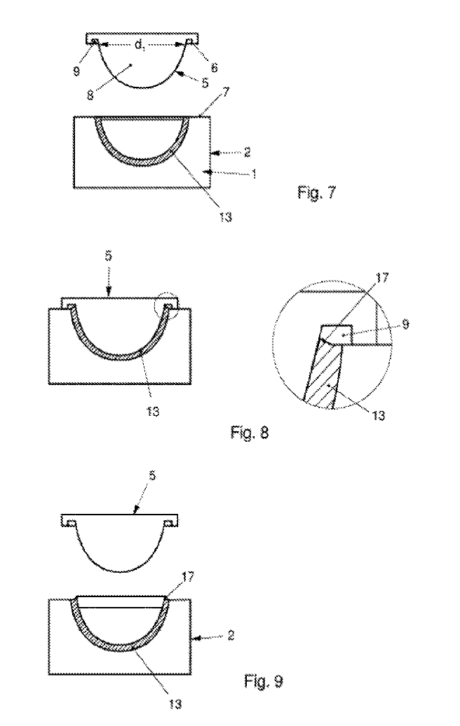

In a second part of the apparatus according to the invention, in FIG. 7, the mold 1 is assigned a second die 5. The latter has a peripheral edge 6 for positioning on a surface 7 of the mold 1. A peripheral groove 9 is provided between the peripheral edge 6 and an actual die body 8. However, said groove is not imperative, as is shown in FIG. 13. The embodiment of the second die A corresponds to that of the first die according to FIGS. 1 and 2; the embodiment of the second die B corresponds to that shown in FIGS. 8 and 9. According to the embodiment E, it is also possible for the peripheral edge to be left out altogether, and therefore there is no groove provided either. In this case, the compression is achieved by a lower pressing depth.

In addition, in the region beneath the groove 9, the die body 8 has a diameter d1, which is slightly larger than a diameter d2 of the first die 4 in this region. In other words, the second die 5 widens slightly in this upper region of the die body 8, which is also located in the region of the shell peripheries which will be described at a later stage in the text.

The method according to the invention for producing the consumable product, in particular the chocolate product, proceeds as follows:

According to FIG. 1, a liquid consumable product, in particular liquid chocolate 3, is introduced into the cavity 2 of the mold 1. The die 4 is then plunged into the mold cavity 2 and into the liquid chocolate 3. This die 4 is a cooled die, its temperature being kept above the dew point of the atmosphere surrounding the consumable article. This is described in DE 197 32 036 A1, to which particular reference is made here. This ensures that the die, which is subjected to the action of a cooling liquid at approximately −20° C., does not become covered with moisture. Since the die for example plunges at a cycle rate of approximately 6 cycles per minute into chocolate heated to 28° C. to 32° C., the temperature of the die surface is increased to approximately 0° C. to −2° C., while the dew point of the atmosphere surrounding the consumable article is kept at approximately −15° C. Even if there are fluctuations in the temperature of the cooling liquid, in the extent to which the air is dehumidified, etc., it is thus reliably ensured that the temperature of the die or of the die surface is always kept above the dew point of the atmosphere surrounding the consumable article.

According to FIG. 2, then, the die 4 comes into contact with a surface 10 of the mold 1 by way of a peripheral edge 6.1. If, when the die 4 plunges into the chocolate substance 3, an excess amount of chocolate substance is forced out of the mold cavity 2, this excess amount 11 is pinched off from the peripheral edge 6.1, as is described in DE 102 21 524 A1, to which reference is likewise made here in full. This results in a shell contour which precisely replicates the interspace between the die 4 and mold cavity 2, closed off by the peripheral edge 6.1. In particular, the resulting shell periphery 12, which corresponds precisely to the course taken by the peripheral edge 6.1, constitutes a relatively smooth termination.

According to FIG. 3, the die 4 has been moved out of the mold 2, and the chocolate substance has now solidified, at least on its surface or the region of its surface, and thus forms a shell shape 13. The figure also shows the ring 14 of excess substance 11 separated from the shell shape 13.

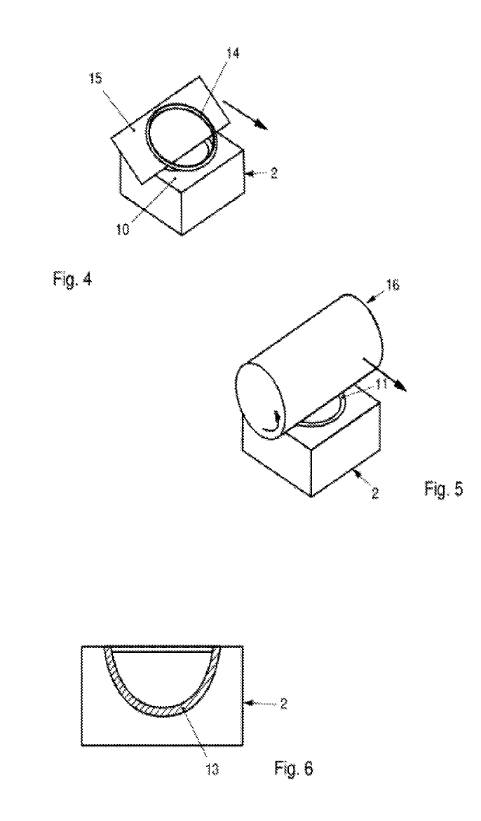

According to FIG. 4, then, this ring 14 can be cut off from the surface 10 of the mold 2 by a scraper 15, as is likewise described in DE 102 21 524 A1. As an alternative to this, it is also possible for the excess substance 11 to be rolled off by a roller 16, referred to as a wiper roller. The result, according to FIG. 6, is a precisely contoured shell shape 13.

The mold 2 with the shell shape 13 is then transported beneath the second die 5 according to FIG. 7. This die 5 is also preferably a cooled die corresponding to DE 197 32 036 and the description relating to the first die.

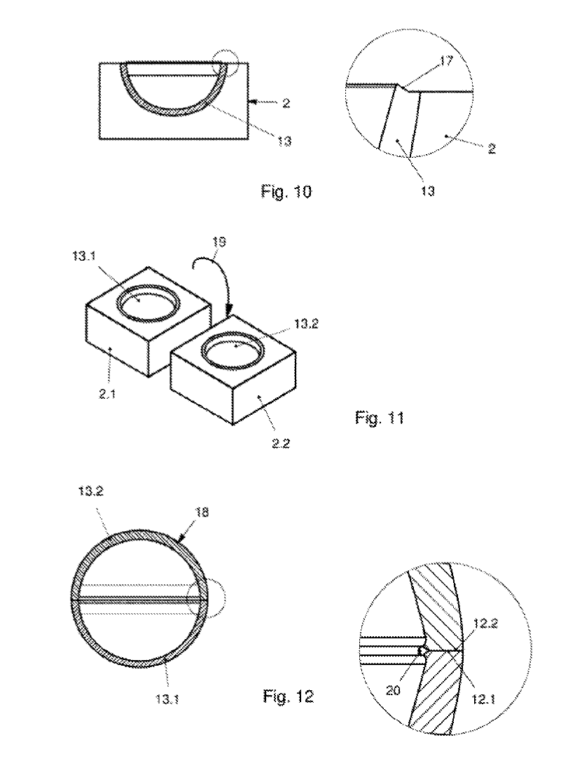

According to FIG. 8, the second die 5 is then plunged into the shell shape 13, which has solidified merely at its surface, but is still soft within. However, the widening of the die 5 as a result of the slightly larger diameter d1 in relation to d2 of the die 4 produces, in the upper region of the shell shape 13, a compressed formation 17, which is formed in a manner similar to a peripheral bead. This takes place by virtue of chocolate substance being displaced in the upper region by the widening of the die 5, it being possible for the compressed formation 17 to yield into the groove 9. The corresponding, finished shell shape 13 is shown in FIGS. 9 and 10.

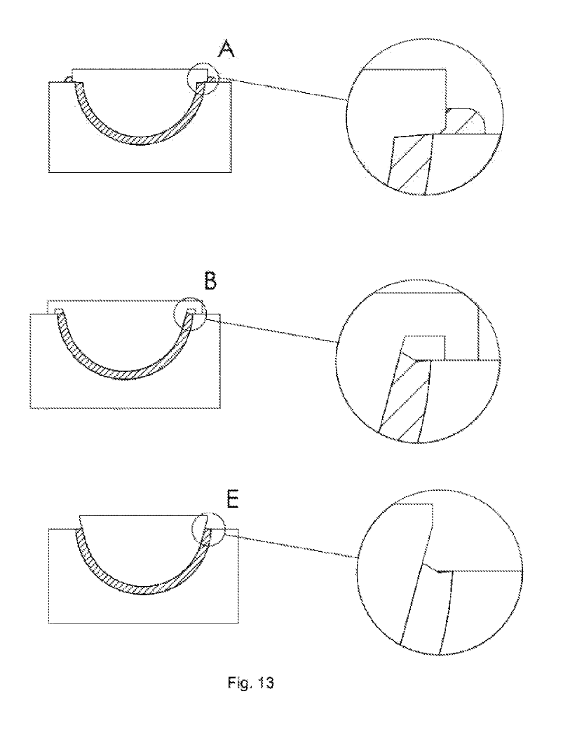

In order to produce a desired hollow body 18 like that illustrated in FIG. 12, then, two molds 2.1 and 2.2 each with a shell shape 13.1 and 13.2 are swung onto one another, as indicated by the arrow 19 in FIG. 11. The two compressed formations 17 here come into contact with one another and form an inwardly directed “kiss mouth” 20 made up of two lips. The shell peripheries 12.1 and 12.2, however, lie flat against one another, and a good connection is therefore ensured.

List of reference signs

| | | | |
|---|---|---|---|
| | Mold | 4 | 7 |
| | Mold cavity | 5 | 8 |
| | Chocolate | 6 | 9 |
| | substance | | |
| | First die | 7 | 0 |
| | Second die | 8 | 1 |
| | Peripheral edge | 9 | 2 |
| | Surface | 0 | 3 |
| | Die body | 1 | 4 |
| | Groove | 2 | 5 |
| 0 | Surface | 3 | 6 |
| 1 | Excess | 4 | 7 |
| | amount/excess | | |
| | substance | | |
| 2 | Shell periphery | 5 | 8 |
| 3 | Shell shape | 6 | 9 |
| 4 | Ring | 7 | |
| 5 | Scraper | 8 | |
| 6 | Roller | 9 | |
| 7 | Compressed | 0 | |
| | formation | | |
| 8 | Hollow body | 1 | |
| 9 | Arrow | 2 | |
| 0 | Kiss mouth | 3 | |
| 1 | | 4 | |
| 2 | | 5 | |
| 3 | | 6 | |
| 4 | | 7 | |
| 5 | | 8 | |
| 6 | | 9 | |
| 7 | | 0 | |
| 8 | | 1 | |
| 9 | | 2 | |
| 0 | | 3 | |
| 1 | | 4 | |
| 2 | | 5 | |
| 3 | | 6 | |

1. A method for producing a consumable product (18), in particular a chocolate product, from at least two shell shapes (13, 13.1, 13.2), which are connected to one another, at least in part, along their shell peripheries (12, 12.1, 12.2), wherein a liquid consumable substance (3) is introduced into a mold (2) and then at least one die (4) is plunged into the consumable substance (3) and, by virtue of the consumable substance (3) at least partially solidifying in the mold, a shell shape (13, 13.1, 13.2) is imparted to said consumable substance, and wherein a second die (5) is introduced into the shell shape (13) and, by virtue of said die, a peripheral region of the shell shape is compressed in the upward direction.

2. The method as claimed in claim 1, wherein the compression (17) takes place along the inner periphery of the shell periphery (12) of the shell shape (13).

3. The method as claimed in claim 1 wherein a compressed formation (17) is accommodated by a groove (9) formed in a peripheral edge (6) of the die (5).

4. The method as claimed in claim 1, wherein a first die (4) and/or the second die (5) are/is a cooled die.

5. The method as claimed in claim 1, wherein the dew point of the atmosphere surrounding the die(s) (4, 5) is kept below the temperature of the die(s).

6. The method as claimed in claim 1, wherein, during production of the shell shape (13), an excess amount of substance (11) along the mold periphery is separated off from the shell shape (13) by means of the die (4).

7. An apparatus for producing a consumable product (18), in particular a chocolate product, from at least two shell shapes (13, 13.1, 13.2), which are connected to one another, at least in part, along their shell peripheries (12, 12.1, 12.2), wherein the apparatus is configured such that a liquid consumable substrate (3) can be introduced into a mold (2) and then at least one die (4) can be plunged into the consumable substance (3), and wherein, by virtue of the consumable substance (3) at least partially solidifying in the mold, a shell shape (13, 13.1, 13.2) is imparted to said consumable substance, wherein the at least one die (4) has arranged downstream of it a further die (5), with an outer contour which differs from that of the first die (4), and wherein, in the region of the shell peripheries (12), the second die (5) has a larger diameter (d1), or is designed to be wider, than the first die (4).

8. The apparatus as claimed in claim 7, wherein, in the region of the shell peripheries (12), the second die (5) has a rectilinear or conical widening in relation to the first die (4).

9. The apparatus as claimed in claim 7, wherein the second die (5) has a peripheral edge (6) by way of which it bears on the mold (2), wherein a groove (9) is formed in the peripheral edge (6) in the region of the shell peripheries (12).

10. The apparatus as claimed in claim 8, wherein characterized in that the second die (5) has a peripheral edge (6) by way of which it bears on the mold (2), wherein a groove (9) is formed in the peripheral edge (6) in the region of the shell peripheries (12).
